(19) United States
(12) Patent Application Publication
(10) Pub. No.: US 2006/0105759 A1
(43) Pub. Date: May 18, 2006

(54) Management server for determining perceived quality of service maps in a mobile communication network

(75) Inventors: Stephane Betge-Brezetz, Paris (FR); Gerard Delegue, Cachan (FR); Arnaud Gonguet, Paris (FR); Julien Robinson, Paris (FR); Lionel Fournigault, Gif Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/252,802

(22) Filed: Oct. 19, 2005

(30) Foreign Application Priority Data
Oct. 20, 2004 (FR) 0411182

(51) Int. Cl. H04Q 7/20

(52) U.S. Cl. 455/422.1; 455/423

(57) ABSTRACT

A management server of a cellular communication network comprises processing means for determining a quality of service map in at least some cells of the network from information sent to said network by at least some of the mobile terminals that have set up radio links within those cells, representing the value taken by at least one quality of service parameter on those connections, and identifiers of the cells in which the corresponding mobile terminals are situated.

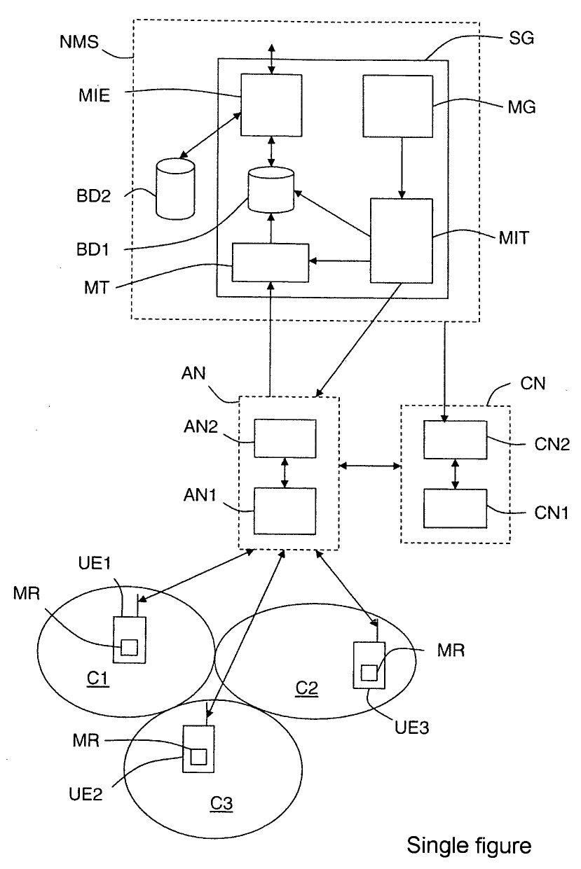

### CROSS-REFERENCE TO RELATED APPLICATIONS

This application is based on French Patent Application No. 0411182 filed Oct. 20, 2004, the disclosure of which is hereby incorporated by reference thereto in its entirety, and the priority of which is hereby claimed under 35 U.S.C. §119.

### BACKGROUND OF THE INVENTION

1. Field of the Invention

The field of the invention is that of mobile (or cellular) communication networks, to be more precise that of controlling quality of service (QoS) in such networks.

2. Description of the Prior Art

Mobile communication network operators and mobile terminal manufacturers make available to their customers an ever-increasing number of services and applications, which makes quality of service control and performance analysis increasingly indispensable.

This necessitates maps of the quality of service in the mobile networks, in order to determine cells in which radio coverage must be improved, track changes in quality of service and verify if the mobile networks are in fact providing the services defined in Service Level Agreements (SLA) between customers and operators.

At least two techniques have been proposed for obtaining these quality of service maps.

A first technique consists in collecting “counter” values from various network equipments, for example base stations (a base station is a BTS or a Node B) and radio network controllers (a radio network controller is an RNC or a BSC), and then aggregating these values to provide indicators representing the quality of service in the various cells of the network, on which the maps are based.

The main drawback of this first technique is that the values collected from the counters and therefore the indicators (which are indispensable for network performance management) represent the quality of service observed by the network equipments and not that actually perceived by the mobile terminals of customers (or “end users”).

In a second technique, using test instruments (or “drive tests”), technicians manually measure the value of a parameter, for example the intensity of a received radio signal, representing the quality of service in at least one location of certain cells of the network, and then produce maps from these manual measurements.

The second technique undoubtedly provides information representing the quality of service actually perceived, but it is costly and labor-intensive and is not exhaustive in that not all the cells can be tested and it is rarely possible to carry out a plurality of measurements at different locations of the cells that can be tested. Moreover, this second technique does not cater for regular updating of the map and therefore cannot be used to control how the quality of service evolves.

A third approach is envisaged in patent application WO 03/081883, which proposes taking account of measurement information sent by portable terminals to construct an overview of the mobile network, in particular in graphic form.

But this prior art is passive, in the sense that the management means cannot be used to influence the nature and the quantity of measurement information sent by the terminals, making it impossible to implement a mapping strategy.

An object of the invention is to improve on the situation whereby no prior art technique proves to be entirely satisfactory.

### SUMMARY OF THE INVENTION

To this end the invention proposes a management server for a mobile (cellular) network including processing means for determining a quality of service map in at least some of said cells of the network from information sent to said network by at least some of said mobile terminals when they have set up radio links in said cells and representing the value of at least one quality of service parameter on said links and from identifiers of the cells in which the corresponding mobile terminals are situated and management means for defining a mapping strategy as a function of at least one configuration parameter.

The management server of the invention may have other features, separately or in combination, and in particular:
the configuration parameter is, by way of nonlimiting example, the designation of the cells covered by the map and/or the mapping period and/or the number of sending mobile terminals per cell and/or the sending period,
interrogation means for generating at chosen times (for example times chosen as a function of each configuration parameter defining the mapping strategy) messages intended for at least some of the sending mobile terminals and requesting them to send the information,
its processing means may determine each map by combining data of map portions each associated with a chosen cell, In this case the server may further comprise storage means for storing data representing each map portion (determined by the processing means) in corresponding relationship to the associated cell,
its processing means may deduce speeds at which the mobile terminals are moving from the information that they send successively, and then determine maps representing reception quality as a function of the speeds deduced,
the interrogation means may store in the storage means each configuration parameter defining each mapping strategy,
interface means for extracting data representing each map from the storage means and delivering it combined with data representing a map of the cells of the network for the purpose of the display thereof,
these interface means may access the storage means to compare a map stored with the parameters defining the corresponding strategy to determine if the map corresponds to the strategy and deliver data representing the result of each comparison and then, where applicable, store data representing the result of each comparison in the storage means,
these interface means may store in the storage means data representing the result of a comparison for the purpose of the display thereof,
these interface means may extract from the storage means data to be displayed associated with a time parameter representing their storage date,
the quality of service parameters may be of any type, for example the intensity of the signal received over a link, the value of an end-to-end performance measurement, for example a server access delay, information as to the bit rate available on a radio connection and information as to the mobile terminal calculation load and/or memory load,
if some information sent to the network represents the location of the sending mobile terminal, the processing means may determine at least some of the maps from the location information received,
if some information sent to the network represents the sending mobile terminal type and/or version and/or the state of charge of the battery of the sending mobile terminal, the processing means may determine at least some of the maps from the type and/or version and/or state of charge information. In this case the processing means may store data representing the maps in the storage means in corresponding relationship to the type and/or version and/or state of charge information.

The invention also proposes a network management system (NMS) for a mobile (cellular) communication network including a management server of the type described above.

The invention is particularly well suited, although not exclusively so, to GSM, GPRS/EDGE, UMTS, WIFI and WIMAX mobile communication networks and to all equivalent mobile networks.

### BRIEF DESCRIPTION OF THE DRAWING

Other features and advantages of the invention will become apparent on reading the following detailed description and examining the appended drawing, the single FIGURE whereof is a highly diagrammatic representation of a mobile (cellular) network equipped with one embodiment of a management server of the invention. The appended drawing constitutes part of the description of the invention as well as contributing to the definition of the invention, if necessary.

### DETAILED DESCRIPTION OF THE PREFERRED EMBODIMENT

One particular object of the invention is to enable control of the quality of service actually perceived by mobile terminals in mobile (cellular) communication networks.

Hereinafter it is considered by way of nonlimiting example that the mobile network is a 3 G cellular communication network, such as a UMTS network. The invention is not limited to that type of network, however. It concerns all mobile (or cellular) communication networks, and in particular 2 G networks, such as GSM networks, 2.5 G networks, such as GPRS or EDGE, 4 G, WIFI and WIMAX networks.

Moreover, in the present context the term “mobile terminal” refers to any mobile or portable communication terminal capable of exchanging data in the form of radio signals, either with another terminal or network equipment via its parent network or with its own parent network. Thus this term might refer, for example, to mobile telephones, fixed or portable computers or personal digital assistants (PDA) equipped with a radio communication module. In the following description it is considered by way of nonlimiting example that the mobile terminals are mobile telephones.

As shown in the single figure, very broadly speaking, but nevertheless in sufficient detail for the invention to be understood, a radio network may be regarded as comprising a core network CN coupled to a radio access network AN (known as the UTRAN in a UMTS network or the BSS in a GSM network), itself connected to a network management system NMS.

The radio access network AN includes a set AN1 of base stations (a base station is known as a Node B in a UMTS network or as a BTS in a GSM network) and radio network controllers or nodes (known as an RNC in a UMTS network or a BSC in a GSM network), connected to each other, and an access network manager AN2 connected to the set AN1. The network management system NMS is connected to the base stations via the radio network controllers.

Each base station (Node B or BTS) is associated with at least one cell Ci covering a radio area in which mobile telephones UEi can set up (or continue) radio links.

In the present example, three cells are shown (C1-C3, i=1 to 3). However, the suffix i may take any non-zero value.

The core network CN comprises a set of network equipments CN1 connected to the radio network controllers (RNC or BSC) of the set AN1 and a core network manager CN2 connected to the set CN1. The network management system NMS is also connected to the core network manager CN2.

The invention proposes using a management server SG to enable control of the quality of service actually perceived by the mobile terminals UEi in the mobile network.

The management server SG is preferably integrated into the network management system NMS, as shown here, but it could equally be installed in a network equipment connected to the latter or in a dedicated unit designed to be connected to the network management system NMS.

The management server SG of the invention comprises at least one processing module MT that is supplied with information coming from certain appropriately adapted mobile telephones UEi, which have set up radio links in certain cells Ci of the network via the access network AN and the network management system NMS, and with information data (or more simply information) representing the value taken on these links by at least one quality of service parameter and identifiers of the cells Ci in which the sending mobile telephones UEi are situated.

The mobile terminals UE that send information useful for mapping are equipped with a reporting module MR for determining internally the value of at least one parameter representing the perceived quality of service when a link is set up and for instructing the sending to the management server SG of a reporting message including each value determined.

The reporting module MR may take the form of electronic circuits, software (or electronic data processing) modules, or a combination of circuits and software.

If this module consists exclusively of software modules, it may be downloaded to the mobile telephones UEi by the network, either at the request of its manager or automatically when it is used for the first time. Alternatively, it may be installed in the mobile telephone UEi at the outset and activated remotely by the operator.

The reporting module MR may be installed in the SIM card of the mobile telephone UEi, for example, which is secure but independent of the mobile telephone UEi, or in the operating system (OS) of the mobile telephone UEi, or in an application situated above the operating system of the mobile telephone UEi, for example in the form of a Java virtual machine (JVM).

The information sent represents the intensity of the signal received by the mobile telephone UEi over the link that it has set up, for example, and/or the value of an end-to-end performance measurement on the link that it has set up with a remote mobile terminal or with a network server (where applicable the management server SG of the invention). The end-to-end measurements represent the transmission delay, the loss rate or the server access delay, for example.

However, any other information may be envisaged, and in particular bit rate information available at the level of the radio connection or information representing the computation (or CPU) load and/or the load on the memory of the mobile terminal UEi.

It is considered hereinafter, by way of nonlimiting example, that the reports cover only one parameter and that this parameter is the received signal intensity. However, another parameter may be envisaged, or a report may cover more than one parameter.

If a mobile telephone UEi has a geographical location function, the information. it sends may also be accompanied by data representing its geographical position. A plurality of solutions may be envisaged for determining the position of the mobile telephone UEi. It may be equipped with a Global Positioning System (GPS) module, for example, an intracellular location module or an intercellular location module employing triangulation, especially if the network is a UMTS network.

When the processing module MT receives the information referred to above, it analyzes the information in order to group it as a function of the cells in which it was determined by the sending mobile telephones UEi. It then aggregates (or combines) the information to produce data representing the quality of service perceived in each cell Ci (which defines quality of service map portions each associated with a cell Ci) and/or data representing the quality of service perceived in the cells (which defines a complete map).

The processing module MT may have one or more values of one or more parameters available for the same cell Ci, such as the delay and the rate loss, for example.

If the processing module MT has only one value available for each parameter of a cell Ci, it delivers an item of quality of service data equal to each parameter value received from the sending mobile telephone UEi. If it has more than one value of the same parameter for a cell Ci, it delivers an item of quality of service data equal to the mean value of the values received. In this latter case, the data corresponding to the same cell Ci may come either from the same mobile telephone UEi (at different times) or from different mobile telephones (situated in the cell Ci). A mean value may also be obtained within a cell Ci as a function in particular of the types of sending mobile telephone UEi and/or the state of charge of their batteries.

If the mobile telephones UEi have a geographical position function, the maps (or map portions) supplied by the processing module MT may take account of the positions of the mobile telephones in the cells Ci in which they are situated at the time. This provides more accurate maps allowing detection of intracellular quality of service disparities, not just intercellular disparities.

Adapting the reporting module MR to integrate additional information into its report messages, for example information representing the type and/or the version of the mobile telephone UEi in which it is installed and/or the state of charge of the battery of said mobile telephone UEi, may also be envisaged.

In this case, the processing module MT can determine at least some of the maps (or map portions) from information representing values of quality of service parameters and information as to the type and/or version and/or state of charge of the mobile telephones UEi from which it has received report messages. It can therefore establish quality of service maps as a function of one or more mobile telephone types and/or versions and/or the state of charge of the battery.

It may equally be envisaged that the processing module MT be adapted to deduce the speed at which a mobile telephone UEi is moving from information contained in successive report messages coming from that mobile telephone UEi. For example, a coarse approximation of the speed may be obtained as a function of the number of cells crossed in a given time period and the dimensions of those cells. Handover (intercellular transfer without interruption) performance may thus be analyzed coarsely since it is from this point onwards possible to obtain a map of reception quality as a function of speed in particular.

The invention also concerns both horizontal handovers, i.e. handovers between cells with the same technology (for example the GSM technology), and vertical handovers, i.e. handovers between cells belonging to different technologies (for example the GSM and UMTS technologies).

It is important to note that any type of crossover of information may be envisaged for establishing a quality of service map. Thus a quality of service map may be produced as a function of an event and/or a day and/or a time of day and/or a particular geographical area. For example, a quality of service map may be produced as a function of calls from a mobile telephone in certain geographical areas.

The management server SG preferably comprises a memory BD1, taking the form of a database, for example, and coupled to the processing module MT in order for it to be able to store therein the mapping data and/or map portions that it has determined, where applicable in correspondence with additional information, for example the type and/or version of the sending mobile telephones, the state of charge of the battery of the sending mobile telephones and/or the date.

At this stage, a map may be regarded as a picture in which each identifier of a cell Ci from which at least one report message is obtained is associated with at least one quality of service parameter value. Of course, certain cell identifiers may be associated with a plurality of quality of service parameter values if the latter are themselves each associated with a precise geographical position.

The management server SG may also include an interface module MIE coupled to the memory BD1 to enable the network manager to view the maps and the associated information (or data) stored therein.

The interface module MIE is preferably coupled to another memory BD2 which stores data representing the map representing the geographical locations of the network cells Ci. By accessing the memories BD1 and BD2, the interface module MIE can combine data defining the map of the cells with (or superpose this data on) data defining a map (or map portions) required by the manager, thus enabling the map to be viewed on top of the map of the cells.

The interface module MIE can also enable different ways of coupling information relating to the maps of the network stored in the memory BD2 and quality of service map data stored in the memory BD1. Thus combining information relating to the height of buildings present in a portion of a cell Ci with quality of service data obtained in that same part of the cell Ci by one or more mobile telephones UEi to determine if a high building is locally degrading the quality of service may be envisaged.

Adapting the reporting module MR installed in the mobile telephones UEi to send automatically messages containing each quality of service parameter value may be envisaged. Such transmission may be effected periodically, each time that the mobile telephone UEi is switched on or each time that the mobile telephone UEi enters a new cell Ci.

However, instead of (or in addition to) this the reporting module MR installed in the mobile telephones UEi may also send a message containing information representative of each quality of service parameter and of the associated cell identifier each time that it receives a dedicated message from the management server SG (or the radio access network AN (UTRAN or BSS)) requesting it to send said information.

To this end, the management server SG may also include a management module MG for defining a mapping strategy coupled to an interrogation module MIT for generating the dedicated messages requesting at least some of the mobile telephones UEi equipped with a reporting module MR to send their mapping information.

To be more precise, the management module MG defines a mapping strategy as a function of at least one configuration parameter. For example, a mapping strategy may be defined by designating one or more cells Ci of the network and/or by a mapping period (time and/or day and/or week and/or month) and/or by the number of mobile terminals UEi having to send their mapping information in each designated cell, in order for the result for that cell to be taken into account, and/or by the period of transmission of mapping information by the mobile terminals UEi situated in each designated cell Ci and/or by the types of mobile telephones UEi, in order to determine the quality of service map as a function of one or more mobile telephone types, and/or by the types of service used (voice, video, etc.) and/or the types of customer/operator contract (gold/silver/bronze). These are merely nonlimiting examples. Other criteria or parameters may be used to define a mapping strategy.

The interrogation module MIT then generates the dedicated messages sent at selected times to selected mobile telephones UEi (where applicable all those equipped with a reporting module MR), as a function of each configuration parameter defining the mapping strategy produced by the management module MG.

Of course, having the management server SG include no management module MG, but simply an interrogation module MIT, for example for generating the dedicated messages sent to predefined groups of mobile telephones UEi (where applicable all of them) automatically, for example periodically, or at the request of the network manager, may be envisaged.

When the interrogation module MIT is coupled to a management module MG, it is equally and preferably coupled to the memory BD1 in order to store therein data representing the mapping strategy produced by the management module MG. It is also coupled to the processing module MT in order to provide it with data defining the configuration strategy that will enable it to determine a map or map portions (especially if the mean values of the quality of service parameters must be obtained from certain cells Ci).

Accordingly, when it accesses the memory BD1, at the request of the network manager, the interface module MIE may extract the data representing a selected map and the data representing the configuration strategy enabling that map to be obtained, in order to determine if said map satisfies the objective defined by said configuration strategy. A map may not satisfy a defined objective because no reporting message has been received from one or more cells Ci and/or the processing module MT has not been able to determine the quality of service value for one or more cells Ci because the number of reporting messages received from that (those) cells did not correspond to the defined configuration strategy.

The result of comparing a map with the configuration strategy used to obtain it may be supplied by the interface module MIE and displayed on a screen of the network manager.

The interface module MIE may also and where applicable store in the memory BD1 the result of comparing a map with the configuration strategy that was used to produce it, for subsequent use.

Generally speaking, the interface module MIE may be adapted to provide, for display, any map and any analysis relating to one or more maps, taking account of any associated stored data and/or additional data, such as weather data, for example.

Correlations may thus be effected to determine the cause or causes of degraded quality of service.

The management server SG of the invention, and in particular its management module MG, its interrogation module MIT, its processing module MT and its interface module MIE, may take the form of electronic circuits, software (or electronic data processing) modules, or a combination of circuits and software.

Thanks to the invention, it is now possible to obtain maps of the quality of service actually perceived by the mobile terminals UEi. Moreover, the invention supplies the network manager automatically and quickly with partial or complete maps of his network and with updates as often as he requires them.

It will be noted that it is equally possible to correlate the quality of service information relating to customers (“end users”), obtained by means of the invention, with other quality of service information coming, for example, from the core network CN or from a service provider (which may be the cause of the degraded quality of service perceived by a mobile telephone).

Moreover, the quality of service information obtained by means of the invention may be used to detect areas in which the quality of service is degraded, for example, in order to carry out therein manual tests (or “drive tests”) intended to provide more accurate measurements.

The invention is not limited to the management server and network management system embodiments described hereinabove by way of example only, but encompasses all variants that the person skilled in the art might envisage that fall within the scope of the following claims.

1. A management server for a mobile communication network including cells in which mobile communication terminals may set up radio links, which server comprises processing means for determining a quality of service map in at least some of said cells from information sent to said network by at least some of said mobile terminals when they have set up radio links in said cells and representing the value of at least one quality of service parameter on said links and from identifiers of the cells in which the corresponding mobile terminals are situated and management means for defining a mapping strategy as a function of at least one configuration parameter.

2. A server according to claim 1, wherein said configuration parameter is chosen from a group comprising at least the designations of the cells covered by said map and/or the period of said mapping and/or the number of sending mobile terminals per cell and/or the sending period and/or the mobile telephone type(s) and/or the service type(s) used and/or the type(s) of customer/operator contract.

3. A server according to claim 1, further comprising interrogation means for generating at chosen times messages intended for at least some of said sending mobile terminals and requesting them to send said information.

4. A server according to claim 3, wherein said times are chosen as a function of each configuration parameter defining said mapping strategy.

5. A server according to claim 4, wherein said processing means determine each map by combining data of map portions associated with each cell concerned and said server further comprises storage means for storing data representing each map portion determined by said processing means in corresponding relationship to the associated cell.

6. A server according to claim 5, wherein said interrogation means store in said storage means each configuration parameter defining each mapping strategy.

7. A server according to claim 6, further comprising interface means for extracting data representing each map from said storage means and delivering it combined with data representing a map of the cells of said network for the purpose of the display thereof.

8. A server according to claim 7, wherein said interface means access said storage means to compare a map stored with the parameters defining the corresponding strategy to determine if said map corresponds to said strategy and then send the result of said comparison.

9. A server according to claim 8, wherein said interface means store in said storage means data representing the result of a comparison.

10. A server according to claim 9, wherein said interface means extract from said storage means data representing a comparison result for the purpose of the display thereof.

11. A server according to claim 7, wherein said interface means extract from said storage means data to be displayed associated with a time parameter representing their storage date.

12. A server according to claim 1, wherein each quality of service parameter is chosen in a group comprising at least the intensity of the signal received over a link, the value of an end-to-end performance measurement, the value of a bit rate available on a radio connection and the value of a mobile terminal calculation load and/or memory load.

13. A server according to claim 1, wherein some of the information sent to said network is information representing the position of the sending mobile terminal and said processing means determine at least some of said maps from said location information.

14. A server according to claim 1, wherein said processing means deduce speeds at which the mobile terminals are moving from the information that they send successively.

15. A server according to claim 14, wherein said processing means determine maps representing reception quality as a function of the speeds deduced.

16. A server according to claim 5, wherein some information sent to said network represents the sending mobile terminal type and/or version and/or the state of charge of the battery of said sending mobile terminal and said processing means determine at least some of said maps from said type and/or version and/or state of charge information.

17. A server according to claim 16, wherein said processing means store data representing said maps in said storage means in corresponding relationship to said type and/or version and/or state of charge and/or type of service used and/or type of customer/operator contract information.

18. A network management system for a mobile communication network including cells in which mobile communication terminals may set up radio links, said system comprising a management server according to claim 1.
